(19) United States
(12) Patent Application Publication
(10) Pub. No.: US 2026/0244507 A1
(43) Pub. Date: Aug. 20, 2026

(54) THREAD EXECUTION METHOD, APPARATUS, ELECTRONIC DEVICE, AND COMPUTER-READABLE STORAGE MEDIUM

(71) Applicant: SHENZHEN TCL NEW TECHNOLOGY CO., LTD., Shenzhen, Guangdong (CN)

(72) Inventors: Guoli KUANG, Shenzhen, Guangdong (CN); Bin ZHONG, Shenzhen, Guangdong (CN)

(73) Assignee: SHENZHEN TCL NEW TECHNOLOGY CO., LTD., Shenzhen, Guangdong (CN)

(21) Appl. No.: 18/852,500

(22) PCT Filed: Feb. 21, 2023
(86) PCT No.: PCT/CN2023/077353

§ 371 Date: Sep. 30, 2024

(30) Foreign Application Priority Data
Apr. 7, 2022 (CN) 202210363999.0

(51) Int. Cl. G06F 9/50

(52) U.S. Cl. CPC G06F 9/5038

(57) ABSTRACT

A thread execution method, an apparatus, an electronic device, and a computer readable storage medium are provided. The method includes: determining a target priority according to a current priority of a first thread when detecting that the first thread awakens a second thread; forwarding the target priority to the second thread, and executing the second thread according to the target priority. Forwarding the target priority to the second thread enables the second thread to execute according to the target priority, thereby improving execution efficiency.

This application claims priority to Chinese Patent Application No. 202210363999.0, filed Apr. 7, 2022 and entitled “THREAD EXECUTION METHOD, APPARATUS, ELECTRONIC DEVICE, AND COMPUTER-READABLE STORAGE MEDIUM”. The entire disclosures of the above application are incorporated herein by reference.

### TECHNICAL FIELD

The present application relates to the field of computer technologies, and in particular to a thread execution method, an apparatus, an electronic device, and a computer-readable storage medium.

### BACKGROUND TECHNOLOGY

With rapid development of computer technologies, types and functions of terminal devices are increasing. An execution or diversity of functions of terminal device systems depends on an execution of threads. The thread is a minimum unit that an operating system can compute and schedule. The thread is included in a process and is an actual operating unit of the process. One thread refers to one single sequential control flow in a process.

### SUMMARY OF INVENTION

### Technical Problem

However, as the functional diversity of terminal equipment systems increases, multiple threads can run concurrently in one process, and each thread executes different tasks in parallel. When multiple threads complete the same system function, there is a problem that the threads wait for each other to execute, resulting in a long system feedback delay.

### Technical Solutions

The present application provides a thread execution method, an apparatus, an electronic device, and a computer-readable storage medium, aiming to solve the technical problem of coordinating an execution priority of a thread and improving an execution efficiency of a system.

To achieve the above objectives, technical solutions adopted by the present application to solve the technical problems are as follows:
In a first aspect, the present application provides a thread execution method, the method including:
determining a target priority according to a current priority of a first thread when detecting that the first thread awakens a second thread;
forwarding the target priority to the second thread, and executing the second thread according to the target priority.

In a second aspect, an embodiment of the present application further provides a thread execution device, including:
a determination module configured to determine a target priority according to a current priority of a first thread when detecting that the first thread awakens a second thread;
an execution module configured to forward the target priority to the second thread, and execute the second thread according to the target priority.

In some embodiments of the present application, the device further includes a return execution module, and the return execution module includes:
a return unit configured to return an execution result of the second thread to the first thread based on the awakening, where the execution result is obtained after the second thread is executed according to the target priority;
an execution unit configured to execute the first thread according to the execution result.

In some embodiments of the present application, the execution unit includes:
a waiting subunit configured to set the first thread to a waiting state when the second thread is executed according to the target priority;
an operating subunit configured to adjust the first thread to an operating state according to the execution result when the first thread receives the execution result.

In some embodiments of the present application, the determination module includes: a recording unit configured to record a number of times the first thread awakens the second thread and the second thread awakens the first thread within a preset time threshold, and obtain a number of behaviors;
a first determination unit configured to determine the target priority according to the current priority of the first thread when the number of behaviors is greater than a preset number threshold.

In some embodiments of the present application, the target priority is higher than or equal to an original priority of the second thread in a system configuration.

In some embodiments of the present application, the determination module includes: a second determination unit configured to directly use the current priority as the target priority.

In some embodiments of the present application, the determination module includes: an acquisition unit configured to acquire a mapping relationship set, where the mapping relationship set includes a mapping relationship between a preset current priority and a preset tartget priority;
a third determination unit configured to determine the target priority corresponding to the current priority of the first thread according to the mapping relationship.

In a third aspect, the embodiments of the present application further provide an electronic device. The electronic device includes a memory, a processor, and a computer program stored in the memory and executable by the processor, where the processor is configured to execute the computer program to implement the steps in the above-mentioned thread execution method.

In a fourth aspect, an embodiment of the present application further provides a computer-readable storage medium, on which a computer program is stored, a processor is configured to execute the computer program to implement the steps in the above-mentioned thread execution method.

### Beneficial Effects

In the embodiments of the present application, when it is detected that the first thread awakens the second thread, the target priority is determined according to the current priority of the first thread, and the target priority is forwarded to the second thread, so that the second thread can be executed according to the target priority. By adjusting the priority of the thread to be awakened for communication, after the priority of the awakened thread is increased, the awakened thread can be executed preferentially, thereby improving execution efficiency.

### BRIEF DESCRIPTION OF THE DRAWINGS

The technical solutions and beneficial effects of the present application will be made apparent by describing in detail the specific implementation methods of the present application in conjunction with accompanying drawings.

FIG. 1 is a schematic diagram of a scenario of a thread execution method of an embodiment of the present application.

FIG. 2 is a flowchart of a thread execution method of an embodiment of the present application.

FIG. 3 is a schematic diagram of a scenario in which a first thread is blocked by a second thread in a thread execution method of an embodiment of the present application.

FIG. 4 is a flowchart of recording an awakened behavior in a thread execution method of an embodiment of the present application.

FIG. 5 is a flowchart of forwarding priority parameters in a thread execution method of an embodiment of the present application.

FIG. 6 is a schematic diagram of a structure of a thread execution device of an embodiment of the present application.

FIG. 7 is a schematic diagram of a structure of an electronic device of an embodiment of the present application.

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments are only some, but not all, embodiments of the present disclosure. Based on the embodiments in the present disclosure, all other embodiments obtained by those skilled in the art without creative efforts shall fall within the protection scope of the present disclosure.

The embodiments of the present application provide a thread execution method, an apparatus, an electronic device, and a computer-readable storage medium. Specifically, the embodiments of the present application provide a thread execution device suitable for an electronic device. The electronic device includes a terminal or a server. The terminal can be a computer, a personal notebook, a mobile phone or other equipment. The server can be an independent physical server, or it can be a server cluster or distributed system composed of multiple physical servers, or it can be a cloud server that provides basic cloud computing services such as cloud services, cloud databases, cloud computing, cloud functions, cloud storage, network services, cloud communications, middleware services, domain name services, security services, content delivery networks (CDNs), and big data and artificial intelligence platforms, etc. The server may be connected directly or indirectly via wired or wireless communications.

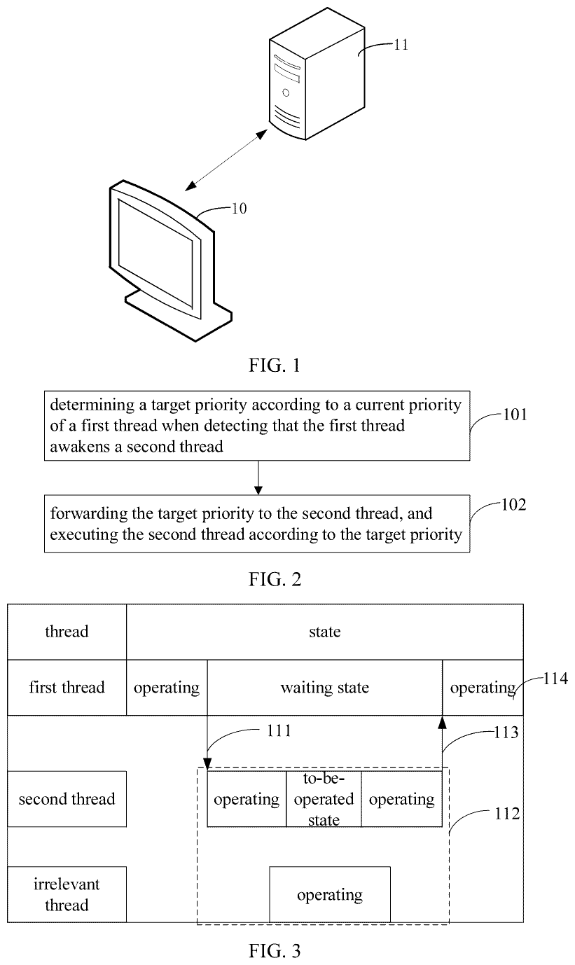

In the embodiments of the present application, the thread execution method can be executed by a terminal device alone, or by a server alone, or by a terminal device and a server together. Please refer to FIG. 1, taking an example of a terminal device and a server jointly executing a thread execution method, other devices can also be added on a basis of the terminal device and the server to assist in completing the thread execution method, and types of other devices are not limited here. The terminal device and the server are connected via a network, such as a wireless network connection, and the specific execution process is as follows:
After responding to a user's triggering operation, a terminal device 10 triggers an execution of a corresponding thread (such as a main thread). During the execution of the thread, a corresponding sub-thread is awakened, and the main thread and the corresponding sub-thread execute together to complete the response or feedback of the user's triggering operation.

When a server 11 detects an awakened operation between threads, it determines a target priority according to a current priority of an awakening thread (such as a first thread). The target priority is forwarded to an awakened thread (such as a second thread), and the awakened thread is executed according to the target priority.

In an embodiment of the present application, the awakening thread may include a main thread of a foreground application, and the awakened thread may include a main thread of a background application. Accordingly, after a user triggers an operation in a user interface of a terminal device, an execution of the main thread of the foreground application is triggered. Subsequently, the main thread of the foreground application performs corresponding response feedback by awakening the main thread of the background application.

In the embodiment of the present application, when it is detected that the first thread awakens the second thread, the target priority is determined according to the current priority of the first thread, and the target priority is forwarded to the second thread, so that the second thread can be executed according to the target priority. By adjusting the priority of the thread awakened for communication, after the priority of the awakened thread is increased, the awakened thread can be executed preferentially, thereby improving execution efficiency.

The following are detailed descriptions. It should be noted that the order of description of the following embodiments does not limit the priority order of the embodiments.

Please refer to FIG. 2, which is a flowchart of a thread execution method of an embodiment of the present application. The specific flow of the thread execution method may be as follows:
101. When it is detected that a first thread awakens a second thread, a target priority is determined according to a current priority of the first thread.

A thread (thread) is a minimum unit that an operating system can compute and schedule. It is included in a process and is an actual operating unit of the process. One thread refers to one single sequential control flow in a process. A plurality of threads can be included in one process, and each thread executes different tasks in parallel. In Unix System V and SunOS, the thread is also referred to as a lightweight process (lightweight processes). However, the lightweight process refers to a kernel thread (kernel thread), and a user thread (user thread) is referred to as a thread.

For example, in an Android Linus (Linux) desktop system, a dynamic setting of a scene depends on an execution of the thread, and the execution of each thread depends on a setting of a corresponding priority. For example, a priority of a foreground application thread is different from that of a background application. In general, a high-priority thread takes precedence over a low-priority thread. By setting the priority of each thread, each thread can be executed in order.

Not all threads are independent during execution. That is, some threads need to awaken other threads to complete system tasks in collaboration. For example, a main thread can assign time-consuming tasks to a child thread to complete. The main thread awakens the child thread to execute. Alternatively, the main thread assigns some tasks to the child thread, and an execution of subsequent tasks of the main thread is completed according to an execution result of the child thread.

In an embodiment of the present application, the first thread refers to a thread that initiates awakening other threads. In an embodiment of the present application, the first thread may include a main thread corresponding to a foreground application.

In an embodiment of the present application, the second thread refers to a thread awakened by other threads. In an embodiment of the present application, the second thread may include the main thread corresponding to the background application.

In an embodiment of the present application, the first thread awakens the second thread by calling a function (handler) to send a message (message) to the second thread. The second thread starts running after receiving the message (message), thereby realizing the first thread awakening the second thread.

The second thread, i.e. the awakened thread, generally includes a child thread, and an execution priority of the child thread is relatively low, the low priority makes it take a long time for the thread to obtain the execution result, and it is difficult to timely feedback the execution result of the first thread. Therefore, in the embodiment of the present application, by determining the target priority, the priority of the second thread is adjusted, the time for the second thread to obtain the execution result is shortened, and the efficiency of the second thread to obtain the execution result is improved.

The determination of the target priority is configured to adjust the priority of the second thread. By determining the target priority through the priority of the first thread, the priority of the second thread can be matched with the priority of the first thread, which facilitates the coordinated execution of the second thread and the first thread.
102. The target priority is forwarded to the second thread, and the second thread is executed according to the target priority.

By determining the target priority according to the priority of the first thread and scheduling the execution of the second thread according to the target priority, the coordinated execution of the second thread and the first thread can be achieved.

For example, in an embodiment of the present application, when the first thread depends on the execution result of the second thread to execute, the priority of the second thread can be appropriately improved to reduce the execution wait of the first thread, avoid execution blocking or jamming, and improve execution efficiency.

For another example, in an embodiment of the present application, when the execution of a system task depends on multiple threads, and there is the first thread that awakens the second thread to execute (at this time, the execution of the first thread does not depend on the execution result of the second thread, and there is only a situation of awakening multiple child threads), the execution efficiency or start execution time of the second thread affects the execution efficiency of the overall system task. Therefore, the priority of the second thread can be adjusted according to the priority of the first thread to speed up the execution of the second thread and speed up the execution efficiency of the overall system task.

In an embodiment of the present application, the first thread may also be executed according to the execution result of the second thread. That is, alternatively, in some embodiments of the present application, after the step of “forwarding the target priority to the second thread, and executing the second thread according to the target priority”, the method further includes:
based on the awakening, returning an execution result of the second thread to the first thread, where the execution result is obtained after the second thread is executed according to the target priority;
executing the first thread according to the execution result.

System execution or configuration of scene dynamic images requires the coordinated execution of multiple threads. Moreover, in complex scenes, mutual wake-up communication between threads is required to complete the execution of the overall task. The mutual wake-up between threads requires waiting for the execution result of the other thread before execution can be performed. When the execution of the first thread depends on the execution result of the second thread, the priority of the second thread can be adjusted. For example, the priority of the second thread can be increased to start the execution earlier, the execution efficiency of the system can be improved, and blocking and lag can be avoided.

In an embodiment of the present application, when the execution of the first thread depends on the execution result of the second thread, the first thread may be set to a waiting state during the execution of the second thread. That is, alternatively, in some embodiments of the present application, the step of “executing the first thread according to the execution result” includes:
when the second thread is executed according to the target priority, setting the first thread to a waiting state;
when the first thread receives the execution result, adjusting the first thread to an operating state according to the execution result.

The waiting state can include a sleeping mode. When the execution of the first thread depends on the execution result of the second thread, and the second thread is executing, the first thread can be set to the waiting state. When the second thread finishes executing, the execution state of the first thread can be adjusted to the operating state, and the first thread can be executed according to the execution result of the second thread.

In an embodiment of the present application, it is also possible to determine whether the priority of the second thread needs to be re-determined according to number of wake-up times. That is, alternatively, in some embodiments of the present application, the step of “determining the target priority according to the current priority of the first thread” includes:
recording a number of times the first thread awakens the second thread and the second thread awakens the first thread within a preset time threshold, and obtaining a number of behaviors;
when the number of behaviors is greater than a preset number threshold, determining the target priority according to the current priority of the first thread.

The first thread awakens the second thread and the second thread awakens the first thread within the preset time threshold, indicating that there is mutual wake-up communication between the first thread and the second thread. For example, the second thread forwards the execution result to the first thread. Based on this, the priority of the second thread can be adjusted according to the priority of the first thread to speed up the execution of the second thread.

In an embodiment of the present application, the target priority is higher than or equal to an original priority of the second thread in a system configuration. The original priority is a normal priority originally carried by the thread. By increasing the priority of the second thread, the execution of the second thread is increased, so that the system tasks corresponding to the first thread and the second thread can be executed and completed as soon as possible.

In an embodiment of the present application, the current priority of the first thread can be directly used as the target priority of the second thread. That is, alternatively, in some embodiments of the present application, the step of “determining the target priority according to the current priority of the first thread” includes:
directly using the current priority as the target priority.

By adjusting the second thread to the same priority as the first thread, the second thread has the same scheduling resources as the first thread, so that the second thread can cooperate with the first thread to execute quickly, solving the thread priority flipping problem (low-priority data cannot be sufficiently scheduled, resulting in a long delay for high-priority threads waiting for shared data).

In an embodiment of the present application, the target priority of the second thread may also be determined according to a mapping relationship between the current priority and the target priority. That is, alternatively, in some embodiments of the present application, the step of “determining the target priority according to the current priority of the first thread” includes:
acquiring a mapping relationship set, where the mapping relationship set includes a mapping relationship between a preset current priority and a preset target priority;
determining the target priority corresponding to the current priority of the first thread according to the mapping relationship.

The mapping relationship set can be established in advance based on actual needs or empirical parameters. According to the mapping relationship set, the target priority required by the second thread can be quickly located.

In an embodiment of the present application, the adjustment of the priority can be achieved by adjusting a corresponding priority parameter. For example, a priority parameter interval is [−20, 19], where the priority parameter −20 corresponds to the highest priority, and the priority parameter 19 corresponds to the lowest priority. The priority parameter can be adjusted to adjust the priority of the thread.

In an embodiment of the present application, after the second thread is executed according to the target priority, the priority of the second thread can be restored to ensure that a system execution stability can be guaranteed when the second thread is awakened by other threads. That is, alternatively, in an embodiment of the present application, after the step of “executing the second thread according to the target priority”, the method further includes:
adjusting a priority of the second thread from the target priority to an original priority in a system configuration.

In an embodiment of the present application, when it is detected that the first thread awakens the second thread, the target priority is determined according to the current priority of the first thread, and the target priority is forwarded to the second thread, so that the second thread can execute according to the target priority. By adjusting the priority of the thread that is awakened to communicate, the priority execution of the awakened thread can be achieved after the priority of the awakened thread is improved, thereby improving the execution efficiency. At the same time, when the execution of the first thread depends on the execution result of the second thread, after the priority execution of the second thread is achieved, the execution efficiency of the first thread can also be improved, and the first thread can be prevented from processing waiting or sleeping mode for a long time, thereby improving the overall execution efficiency of the system (asynchronous calls between threads of different priorities in the Android system). This solves the problem that when asynchronous calls are made between threads of different priorities, the asynchronous thread (second thread) is preempted due to its low priority, blocking the main critical thread (first thread) from running.

Since the second thread (such as the child thread) is easily in a waiting state due to insufficient resource scheduling (such as schedulable resources being occupied) during execution, the first thread cannot obtain feedback from the second thread in a timely manner, causing the first thread to be blocked, affecting the execution efficiency of the system. For example, please refer to FIG. 3, which is a schematic diagram of a scenario in which the first thread is blocked by the second thread according to an embodiment of the present application, as follows:
During the execution of the first thread, the first thread calls the function (handler) to send a message (message) to awaken the second thread. The first thread needs to wait for the execution result of the second thread before it can proceed with the subsequent execution. Therefore, during the execution of the second thread, the first thread is in the waiting state (sleeping mode).
The second thread starts to execute after being awakened by the first thread. However, since the priority of the second thread is lower, it needs to wait for other threads that are not related to the current task to finish before it can execute. Therefore, the second thread is in the waiting state for a long time and will continue to execute only after the unrelated threads release resources.
After re-execution, the second thread calls the function (handler) to send a message (message) to awaken the first thread and then terminate the operation.
The first thread performs subsequent execution based on the execution result of the second thread to complete the system task.

There is a situation where the first thread and the second thread wake up each other. For example, the execution of the first thread depends on the execution result of the second thread. Therefore, when there is a waiting delay in the execution of the second thread, the execution of the first thread is affected. Therefore, the embodiment of the present application can adjust the execution priority of the second thread to speed up the execution of the second thread and reduce the execution waiting time of the first thread.

For example, please refer to FIG. 3. When the first thread is running, it calls the handler to send a message to the second thread. After receiving the message, the second thread starts running. After sending the message, the first thread enters the waiting state. That is, it waits for the second thread to return a message before proceeding to the next step, and it continues to run until the second thread finishes running and returns a message. If the priority parameter is not forwarded to the second thread, since the second thread is allocated less time and has a low priority parameter, its scheduling resources are preempted by irrelevant threads, affecting the execution of the second thread, which in turn blocks the first thread and reduces the execution efficiency of the system.

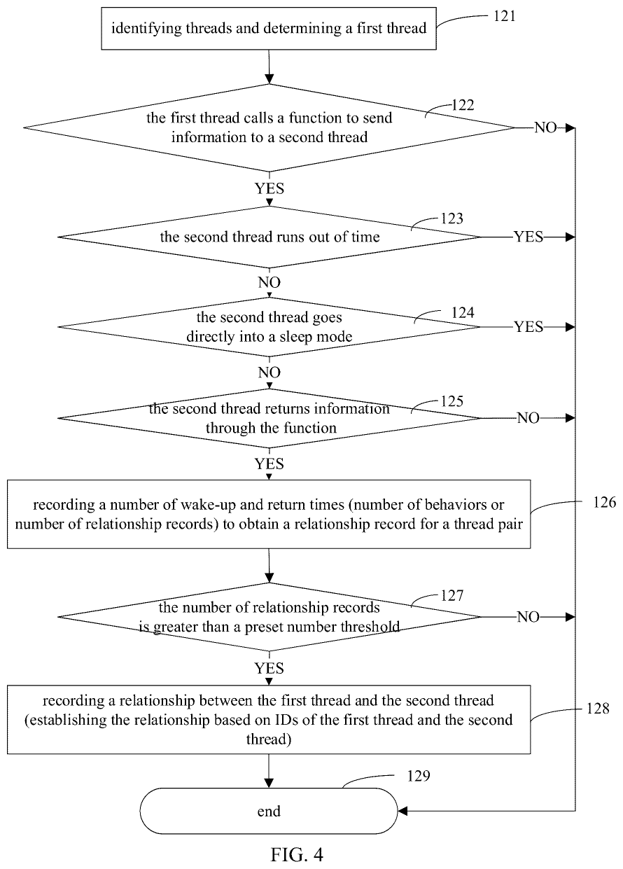

Please refer to FIG. 4, which is a flowchart of recording the wake-up behavior of an embodiment of the present application, which is as follows:
Identify threads and determine a first thread (identify a key thread);
Determine whether the first thread calls a function (handler) to send information (message) to a second thread. If yes, execute a step 123, if no, execute a step 129;
Determine whether the second thread has timed out. If no, execute a step 124, if yes, execute a step 129;
After the second thread finishes running, determine whether the second thread directly enters a sleep mode. If no, execute a step 125, if yes, execute a step 129;
Determine whether the second thread returns information (message) to the first thread through the function (handler). If yes, execute a step 126, if no, execute a step 129;
Record a number of wake-up and return times (number of behaviors or number of relationship records) to obtain a thread relationship record;
Determine whether the number of relationship records in the thread relationship record is greater than a preset number threshold. If yes, execute a step 128, if no, execute a step 129;
Record a relationship pair between the first thread and the second thread (establish the relationship pair based on IDs of the first thread and the second thread);
End.

The behavior of the first thread awakening the second thread and the second thread awakening the first thread within the preset time threshold indicates that there is a collaborative relationship between the first thread and the second thread. For example, the execution of the first thread may depend on the execution result of the second thread.

In the embodiment of the present application, in order to improve the accuracy of priority adjustment, the priority parameter is adjusted only after the number of behaviors exceeds the preset number threshold. This enables the priority parameter to be transferred after the preset number threshold is met, and the priority of the second thread is adjusted, thereby speeding up the start execution time of the second thread.

In an embodiment of the present application, the wake-up behavior can be recorded in a call relationship management list. After the subsequent thread wakes up, the priority parameter is passed according to the relationship management list. For example, by collecting asynchronous call features between threads. If a asynchronous call behavior recording module records that a high-priority thread asynchronously awakens a low-priority thread, and the low-priority thread asynchronously awakens the high-priority thread after a period of time, and the number of behaviors exceeds a preset number, it is considered that the asynchronous call needs to transmit thread priority (the priority parameter of the high-priority thread is transmitted to the low-priority thread). The call relationship management list is generated based on the number of records. When the application is restarted and an asynchronous call relationship occurs, the call relationship management list is queried at the same time to decide whether to pass the priority parameter.

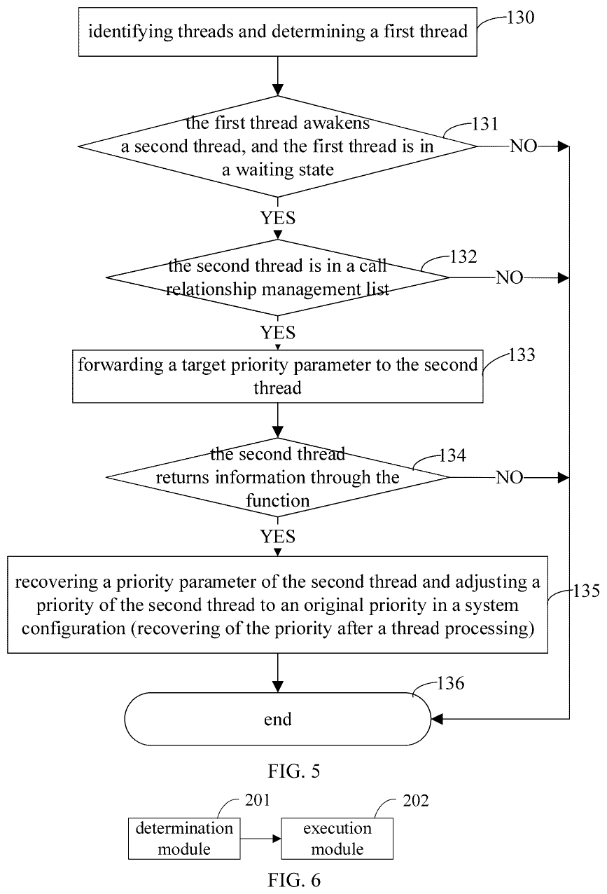

For example, please refer to FIG. 5, which is a flowchart of forwarding priority parameters of an embodiment of the present application, which is as follows:
Identify threads and determine a first thread (identify a key thread);
Determine whether the first thread awakens a second thread and the first thread is in a waiting state. If yes, execute a step 132, if not, execute a step 136;
Determine whether the second thread is in a call relationship management list. If yes, execute a step 133, if not, execute a step 136;
Forward a target priority parameter to the second thread (awakened thread) so that the second thread can execute according to the priority corresponding to the priority parameter;
Determine whether the second thread returns information (message) through the function (handler) after the second thread ends its operation. If yes, execute a step 135, if not, execute a step 136;
Recover a priority parameter of the second thread and adjust a priority of the second thread to an original priority in a system configuration (recovering of the priority after a thread processing);
End.

By adjusting the priority of the second thread, the execution of the second thread is accelerated, and the priority is recovered after the second thread is completed, so that the second thread can execute threads according to a default priority order, ensuring the stability of the system.

In order to better implement the thread execution method of the present application, the present application also provides a thread execution device based on the above thread execution method. A meaning of third target terms is the same as that in the above thread execution method, and specific implementation details can refer to the description in the method embodiment.

Please refer to FIG. 6, which is a schematic diagram of a structure of a thread execution device of the present application, where the thread execution device may include the following: A determination module 201 is configured to determine a target priority according to a current priority of a first thread when detecting that the first thread awakens a second thread.

An execution module 202 is configured to forward the target priority to the second thread, and execute the second thread according to the target priority.

In some embodiments of the present application, the device further includes a return execution module, and the return execution module includes the following:
A return unit is configured to return an execution result of the second thread to the first thread based on the awakening, and the execution result is obtained after the second thread is executed according to the target priority.
An execution unit is configured to execute the first thread according to the execution result.

In some embodiments of the present application, the execution unit includes the following:
A waiting subunit is configured to set the first thread to a waiting state when the second thread is executed according to the target priority.
An operating subunit is configured to adjust the first thread to an operating state according to the execution result when the first thread receives the execution result.

In some embodiments of the present application, the determination module 201 includes the following:
A recording unit is configured to record a number of times the first thread awakens the second thread and the second thread awakens the first thread within a preset time threshold, and obtain a number of behaviors.
A first determination unit is configured to determine the target priority according to the current priority of the first thread when the number of behaviors is greater than a preset number threshold.

In some embodiments of the present application, the target priority is higher than or equal to an original priority of the second thread in a system configuration.

In some embodiments of the present application, the determination module 201 includes: a second determination unit configured to directly use the current priority as the target priority.

In some embodiments of the present application, the determination module 201 includes the following:
An acquisition unit is configured to acquire a mapping relationship set, and the mapping relationship set includes a mapping relationship between a preset current priority and a preset target priority.
A third determination unit is configured to determine the target priority corresponding to the current priority of the first thread according to the mapping relationship.

In the embodiment of the present application, when the determination module 201 detects that the first thread awakens the second thread, the target priority is determined according to the current priority of the first thread. Then, the execution module 202 forwards the target priority to the second thread and executes the second thread according to the target priority.

In the embodiment of the present application, when it is detected that the first thread awakens the second thread, the target priority is determined according to the current priority of the first thread, and the target priority is forwarded to the second thread, so that the second thread can execute according to the target priority. By adjusting the priority of the thread to be awakened, the priority of the awakened thread can be improved to achieve the priority execution of the awakened thread and improve the execution efficiency. At the same time, when the execution of the first thread depends on the execution result of the second thread, after the priority execution of the second thread is achieved, the execution efficiency of the first thread can also be improved, avoiding the first thread from processing the waiting or sleeping mode for a long time, and improving the overall execution efficiency of the system.

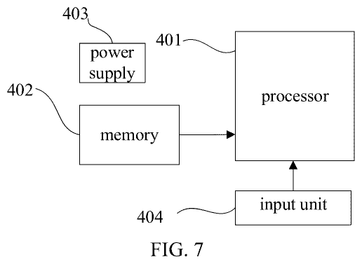

In addition, the present application also provides an electronic device. As shown in FIG. 7, which shows a schematic diagram of a structure of an electronic device in the present application, specifically:
The electronic device may include a processor 401 having one or more processing cores, a memory 402 having one or more computer-readable storage mediums, a power supply 403, an input unit 404, and the like. A person skilled in the art may understand that the structure of the electronic device shown in FIG. 7 does not constitute a limitation to the electronic device, and may include more or fewer components than those shown in the figure, or some components may be combined, or different component arrangements may be used.
The processor 401 is a control center of the electronic device, is connected to various parts of the entire electronic device by using various interfaces and lines, and performs various functions of the electronic device and processes data by running or executing a software program and/or module stored in the memory 402, and invoking data stored in the memory 402. Alternatively, the processor 401 may include one or more processing cores. Preferably, the processor 401 may integrate an application processor and a modem processor. The application processor mainly processes an operating system, a user interface, an application program, and the like. The modem processor mainly processes wireless communication. It may be understood that the foregoing modem processor may also not be integrated into the processor 401.

The memory 402 may be configured to store a software program and module. The processor 401 runs the software program and module stored in the memory 402, to implement various functional applications and data processing. The memory 402 mainly may include a program storage region and a data storage region. The program storage region may store an operating system, an application required by at least one function (for example, a voice playback function, or an image playback function), and the like, and the data storage region may store data created according to use of the electronic device, and the like. In addition, the memory 402 may include a high speed random access memory, and may also include a non-volatile memory, such as at least one magnetic disk storage device, a flash memory, or another volatile solid-state storage device. Correspondingly, the memory 402 may further include a memory controller, so that the processor 401 accesses the memory 402.

The electronic device further includes the power supply 403 for supplying power to the components. Preferably, the power supply 403 may be logically connected to the processor 401 by using a power management system, thereby implementing functions such as charging, discharging, and power consumption management by using the power management system. The power supply 403 may further include one or more of a direct current or alternating current power supply, a re-charging system, a power failure detection circuit, a power supply converter or inverter, a power supply state indicator, and any other components.

The electronic device may further include the input unit 404. The input unit 404 may be configured to receive input digit or character information, and generate a keyboard, mouse, joystick, optical, or track ball signal input related to user settings and functional control.

Although not shown, the electronic device may further include a display unit, etc., which will not be described in detail herein. Specifically, in this embodiment, the processor 401 in the electronic device loads executable files corresponding to processes of the one or more applications to the memory 402 according to the following instructions, and the processor 401 runs the application program in the memory 402, to implement the steps in any thread execution method provided in the present application.

In the embodiment of the present application, when it is detected that the first thread awakens the second thread, the target priority is determined according to the current priority of the first thread, and the target priority is forwarded to the second thread, so that the second thread can execute according to the target priority. By adjusting the priority of the thread to be awakened, the priority of the awakened thread can be improved to achieve the priority execution of the awakened thread and improve the execution efficiency. At the same time, when the execution of the first thread depends on the execution result of the second thread, after the priority execution of the second thread is achieved, the execution efficiency of the first thread can also be improved, avoiding the first thread from processing the waiting or sleeping mode for a long time, and improving the overall execution efficiency of the system.

It will be appreciated by those skilled in the art that all or part of the steps in the various methods of the above embodiments may be completed by instructions, or by controlling related hardware through instructions. The instructions may be stored in a computer-readable storage medium and loaded and executed by a processor.

To this end, the present application provides a computer-readable storage medium in which a computer program is stored. The computer program can be loaded by a processor to execute the steps of any thread execution method provided by the present application.

The computer-readable storage medium may include: a read-only memory (ROM), a random access memory (RAM), a magnetic disk or an optical disk, etc.

Since the instructions stored in the computer-readable storage medium can execute any step in the image processing provided in the present application, the beneficial effects that can be achieved by any thread execution method provided in the present application can be achieved. Please refer to the previous embodiments for details and will not be repeated here.

The above is a detailed introduction to the thread execution method, the apparatus, the electronic device, and the computer-readable storage medium provided by the present application. Specific examples are used herein to illustrate the principles and implementation methods of the present invention. The description of the above embodiments is only used to help understand the method of the present invention and its core idea. At the same time, for those skilled in the art, according to the idea of the present invention, there will be changes in the specific implementation methods and application scopes. In summary, the content of this specification should not be understood as limiting the present invention.

1. A thread execution method, comprising:
determining a target priority according to a current priority of a first thread when detecting that the first thread awakens a second thread;
forwarding the target priority to the second thread, and executing the second thread according to the target priority.

2. The method according to claim 1, wherein after the target priority is forwarded to the second thread and the second thread is executed according to the target priority, the method further comprises:
based on the awakening, returning an execution result of the second thread to the first thread, wherein the execution result is obtained after the second thread is executed according to the target priority;
executing the first thread according to the execution result.

3. The method according to claim 2, wherein executing the first thread according to the execution result comprises:
when the second thread is executed according to the target priority, setting the first thread to a waiting state;
when the first thread receives the execution result, adjusting the first thread to an operating state according to the execution result.

4. The method according to claim 1, wherein determining the target priority according to the current priority of the first thread comprises:
recording a number of times the first thread awakens the second thread and the second thread awakens the first thread within a preset time threshold, and obtaining a number of behaviors;
when the number of behaviors is greater than a preset number threshold, determining the target priority according to the current priority of the first thread.

5. The method according to claim 1, wherein the target priority is higher than or equal to an original priority of the second thread in a system configuration.

6. The method according to claim 1, wherein determining the target priority according to the current priority of the first thread comprises:
directly using the current priority as the target priority.

7. The method according to claim 1, wherein determining the target priority according to the current priority of the first thread comprises:
acquiring a mapping relationship set, wherein the mapping relationship set comprises a mapping relationship between a preset current priority and a preset target priority;
determining the target priority corresponding to the current priority of the first thread according to the mapping relationship.

8. The method according to claim 1, wherein after executing the second thread according to the target priority, the method further comprises:
adjusting a priority of the second thread from the target priority to an original priority in a system configuration.

9. A thread execution device, comprising:
a determination module configured to determine a target priority according to a current priority of a first thread when detecting that the first thread awakens a second thread;
an execution module configured to forward the target priority to the second thread, and execute the second thread according to the target priority.

10. The device according to claim 9, wherein the device further comprises a return execution module, and the return execution module comprises:
a return unit configured to return an execution result of the second thread to the first thread based on the awakening, wherein the execution result is obtained after the second thread is executed according to the target priority;
an execution unit configured to execute the first thread according to the execution result.

11. The device according to claim 10, wherein the execution unit comprises:
a waiting subunit configured to set the first thread to a waiting state when the second thread is executed according to the target priority;
an operating subunit configured to adjust the first thread to an operating state according to the execution result when the first thread receives the execution result.

12. The device according to claim 9, wherein the determination module comprises:
a recording unit configured to record a number of times the first thread awakens the second thread and the second thread awakens the first thread within a preset time threshold, and obtain a number of behaviors;
a first determination unit configured to determine the target priority according to the current priority of the first thread when the number of behaviors is greater than a preset number threshold.

13. The device according to claim 9, wherein
the target priority is higher than or equal to an original priority of the second thread in a system configuration.

14. The device according to claim 9, wherein the determination module comprises:
a second determination unit configured to directly use the current priority as the target priority.

15. The device according to claim 9, wherein the determination module comprises:
an acquisition unit configured to acquire a mapping relationship set, wherein the mapping relationship set comprises a mapping relationship between a preset current priority and a preset target priority;
a third determination unit configured to determine the target priority corresponding to the current priority of the first thread according to the mapping relationship.

16. The device according to claim 9, wherein the execution module further comprises:
an adjustment unit configured to adjust a priority of the second thread from the target priority to an original priority in a system configuration.

17. An electronic device, comprising a memory, a processor, and a computer program stored in the memory and executable by the processor, wherein the processor is configured to execute the computer program to implement:
determining a target priority according to a current priority of a first thread when detecting that the first thread awakens a second thread;
forwarding the target priority to the second thread, and executing the second thread according to the target priority.

18. The electronic device according to claim 17, wherein the processor is further configured to execute the computer program to implement:
based on the awakening, returning an execution result of the second thread to the first thread, wherein the execution result is obtained after the second thread is executed according to the target priority;
executing the first thread according to the execution result.

19-20. (canceled)

21. The electronic device according to claim 17, wherein the processor is further configured to execute the computer program to implement:
when the second thread is executed according to the target priority, setting the first thread to a waiting state;
when the first thread receives the execution result, adjusting the first thread to an operating state according to the execution result.

22. The electronic device according to claim 17, wherein the processor is further configured to execute the computer program to implement:
recording a number of times the first thread awakens the second thread and the second thread awakens the first thread within a preset time threshold, and obtaining a number of behaviors;
when the number of behaviors is greater than a preset number threshold, determining the target priority according to the current priority of the first thread.
